(19) United States
(12) Patent Application Publication
(10) Pub. No.: US 2011/0279097 A1
(43) Pub. Date: Nov. 17, 2011

(54) SYSTEM AND METHOD FOR USING CONDITION SENSORS/SWITCHES TO CHANGE CAPACITANCE VALUE

(76) Inventors: David Wise, Daytona Beach, FL (US); Steven Bruce Fish, South Daytona, FL (US); Rory Daniel Malisoft, Daytona Beach Shores, FL (US)

(21) Appl. No.: 13/107,864

(22) Filed: May 13, 2011

Related U.S. Application Data
(60) Provisional application No. 61/334,273, filed on May 13, 2010.

(51) Int. Cl. G05F 1/70

(52) U.S. Cl. 323/209

(57) ABSTRACT

A system and method for changing reactive compensation of an electrical system, more specifically, the present invention relates to a system and method for changing and optimizing reactive compensation of a system by using environmental condition sensors to detect conditions that may affect the load in the system. One or more sensors or switches may comprise a plurality of environmental condition sensors used to monitor temperature, humidity, barometric pressure, precipitation, solar load, air impurities, wind speed and the like in additional to a plurality of switches used to adjust, regulate, or optimize reactive compensation within the system.

### CROSS REFERENCE TO RELATED APPLICATIONS

This application claims the benefit of provisional patent application Ser. No. 61/334,273, filed with the USPTO on May 13, 2010, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to a system and method for changing capacitance of a system, more specifically, the present invention relates to a system and method for changing and optimizing capacitance of a system by using environmental condition sensors to detect conditions that affect the amount of inductance in the system.

2. Background Art

The Invention relates to the field of power factor correction in general. Specifically, the Invention comprises a power factor correcting circuit in electrical communication with a power source and a load. The power factor correcting circuit is comprised of an internal reactive load or plurality of loads, such as an electrical capacitance, that operate to improve the electrical power factor of the system, and is further comprised of an environmentally controlled switch that operates place the internal reactive load into or out of operation in the circuit. In this manner, the variations in power factor caused by environmental effects on the load are compensated as a function of the changing environmental conditions. The benefits of the present invention include increased power factor, increased efficiency, reduced power consumption, and reduced energy costs.

The power factor, and therefore the electrical efficiency, of a system can be affected by a wide variety of elements. For example, the inductance and current draw of a household electrical system may be influenced by the activity or non-activity of home appliances or other electrical devices. During warmer summer months, air conditioning units may draw greater currents when the air conditioning unit is actively cooling the home. Likewise during dry months or non-rain periods, rain or humidity sensors may activate or trigger a home's outdoor sprinkler system, which may in turn trigger a well pump motor to provide water to the lawn, presenting a greater inductive load to the home's source of electric power for the time the sprinkler system is on.

The power factor of an AC electric power system is defined as the ratio of the real power flowing to the load to the apparent power in the circuit, and is a dimensionless number between 0 and 1 (frequently expressed as a percentage, e.g. 0.5 pf=50% pf). Real power is the capacity of the circuit for performing work in a particular time. Apparent power is the product of the current and voltage of the circuit. Due to energy stored in the load and returned to the source, or due to a non-linear load that distorts the wave shape of the current drawn from the source, the apparent power will usually be greater than the real power in any real application.

In an electric power system, a load with a low power factor draws more current than a load with a high power factor for the same amount of useful power transferred. The higher currents in the low power factor system increase the energy lost in the distribution system, and require larger (i.e. more expensive) wires and other equipment. Because of the costs of larger equipment and wasted energy, electrical utilities will usually charge a higher cost to industrial or commercial customers where there is a low power factor.

Linear loads with low power factor (such as induction motors) can be corrected with a passive network of capacitors or inductors. Non-linear loads, such as rectifiers, distort the current drawn from the system. In such cases, active or passive power factor correction may be used to counteract the distortion and raise the power factor. The devices for correction of the power factor may be at a central substation, spread out over a distribution system, installed at the power service entrance of the facility, or built into power-consuming equipment.

It is usually desirable to adjust the power factor of a system to near 1.0. This power factor correction (PFC) is typically achieved by switching in or out banks of inductors or capacitors. For example the inductive effect of motor loads may be offset by locally connected capacitors. When reactive elements supply or absorb reactive power near the load, the apparent power is reduced.

Power factor correction may be applied by an electrical power transmission utility to improve the stability and efficiency of the transmission network. Correction equipment may be installed by individual electrical customers to reduce the costs charged to them by their electricity supplier. A high power factor is generally desirable in a transmission system to reduce transmission losses and improve voltage regulation at the load.

Power factor correction brings the power factor of an AC power circuit closer to 1 by supplying reactive power of opposite sign, adding capacitors or inductors which act to cancel the inductive or capacitive effects of the load, respectively. For example, the inductive effect of motor loads may be offset by locally connected capacitors. If a load had a capacitive value, inductors (also known as reactors in this context) are connected to correct the power factor. In the electricity industry, inductors are said to consume reactive power and capacitors are said to supply it, even though the reactive power is actually just moving back and forth on each AC cycle.

The reactive elements can create voltage fluctuations and harmonic noise when switched on or off. They will supply or sink reactive power regardless of whether there is a corresponding load operating nearby, increasing the system's no-load losses. In a worst case, reactive elements can interact with the system and with each other to create resonant conditions, resulting in system instability and severe overvoltage fluctuations. As such, reactive elements cannot simply be applied at will, and power factor correction is normally subject to engineering analysis or testing to appropriately size the reactive elements.

It is therefore desirable that the reactive elements utilized to compensate and correct power factor be switched into and out of the power circuit as environmental changes such as temperature, humidity, precipitation, barometric pressure, solar load, wind speed, and the like cause the various electrical loads of the system to draw more or less power and to present varying reactive electrical loads to the power source.

The concept of adding capacitance to correct for power factor is known in the art. One of the most typical applications is to install capacitor(s) at the service entrance of a facility. In many instances these capacitors may be a fixed value or they may comprise a system that switches capacitors in and out to keep the power factor within a certain range.

The adapter and method of the invention overcome the shortcomings of the prior art by switching reactive elements into or out of the electrical power system based on the state of environmental conditions.

### BRIEF SUMMARY OF THE INVENTION

The present invention comprises a system and method that have one or more of the following features and/or steps, which alone or in any combination may comprise patentable subject matter.

In accordance with one embodiment of the present invention, the invention comprises a system for optimizing capacitance to achieve power efficiency by correcting factor over varying environmental conditions. As used herein, “environmental conditions” means variations in temperature, humidity, solar load, barometric pressure, precipitation, and other like variables that may affect the electrical current requirements of the load. As an example, an increased solar load on home may result in an increased inductive loading by the motors and controllers associated with the air conditioning or other cooling systems that operate to lower the temperature of the home. The system of the invention operates to switch capacitance in or out of the system based upon the environmental conditions by using sensors to operate switches in electrical communication with capacitors or banks of capacitors. When said capacitors or banks of capacitors are switched into the circuit they serve to compensate for the increasing inductive loading caused by the changing environmental condition.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a simplified line diagram of a first embodiment of the system of the present invention in which the entire capacitive compensation circuit is switched into or out of operation by operation of an environmentally controlled switch.

FIG. 2 depicts a line diagram of a second embodiment of the system of the present invention in which only a portion of the capacitive compensation circuit is switched into or out of operation by operation of an environmentally controlled switch.

FIG. 3 depicts a line diagram of a third embodiment of the system of the present invention in which a plurality of environmentally controlled switches operate to place capacitive compensation circuits into or out of operation.

FIG. 4 depicts a line diagram of a fourth embodiment of the system of the invention in which a portion of the capacitive compensation circuit is switched into or out of operation by operation of a plurality of environmentally controlled switches.

FIG. 5. Depicts a microprocessor-controlled embodiment of the system in which a microprocessor receives input from environmental sensors and determines which elements of the capacitive compensation circuits to place into operation in the system.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

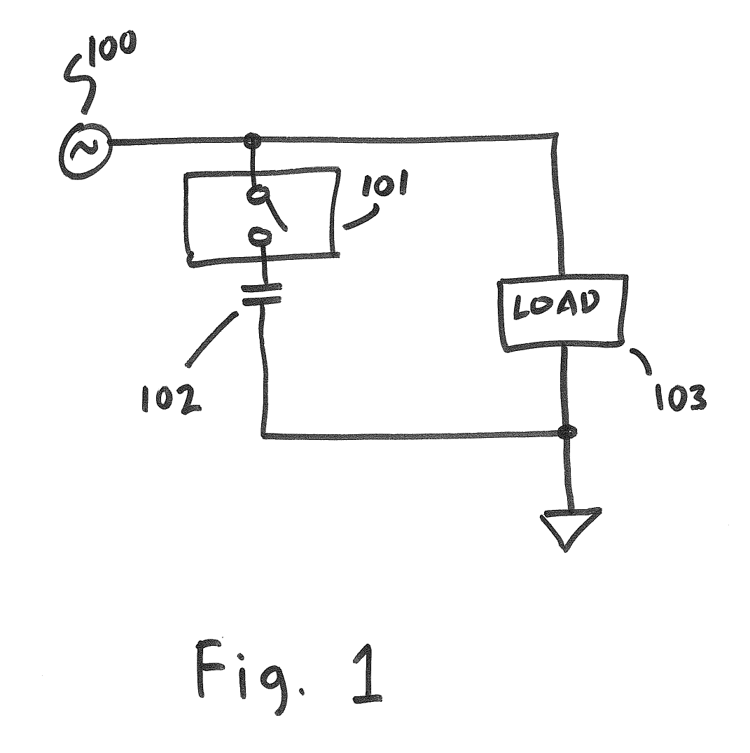

A first embodiment of the present invention is illustrated in FIG. 1. In this simplified embodiment, power source 100, which may by any source of alternating current power such as electrical power mains, is in electrical communication with, and provides power to, load 103. Load 103 is any electrical load that is powered by alternating current source 100 such as, for example, the motors and other electrical loads of an air condition system, pool pumps, pool heaters, water pumps, household appliances, electrical tools, industrial motors, and any electrical load comprised of either a single electrical device or a plurality of electrical devices. The particular type of electrical load 103 is not intended to be a limitation of the system of the invention.

Referring still to FIG. 1, switch 101 is an Environmentally Controlled Switch. An Environmentally Controlled Switch is an electrical switch that is coupled with an environmental sensor such that it opens or closes based upon the state of a specific environmental condition. Certain types of Environmentally Controlled Switches are known in the art. For instances, Environmentally Controlled Switches that are operated by sensing temperature, known as thermostats, are commonly used to turn air conditioning systems on when the environmental temperature exceeds a specified temperature, and to turn air conditioning systems OFF when the environmental temperature falls below a specified temperature. Such thermostats are commonly used in numerous residential, commercial, and industrial applications. Environmentally Controlled Switch 101 may also be controlled by other environmental conditions, for example humidity, solar load, precipitation, wind speed, or barometric pressure. This list of environmental conditions is for example only; the intended scope of the Environmentally Controlled Switch is that it operates to close or open based upon any environmental condition that is able to be sensed. This may also include, for example, radiation levels, presence of undesired chemicals or other agents, bacteria, fungus, pollen, smoke, fire, or any other monitorable conditions. As used herein, Environmentally Controlled Switch means any switch that is controlled by a sensor as described herein.

Referring still to FIG. 1, Capacitive Compensation Circuit 102 is a capacitor or plurality of capacitors. Capacitive Compensation Circuit 102 may be comprised, for example, of more than one capacitor wired in parallel to present a single capacitance to the circuit. This combination is also known in the art as a capacitor bank. Electrically parallel combinations of capacitors may be desirable in situations in which it is desired to place a higher capacitance value than can be feasibly or economically achieved in a single capacitor in the circuit. Alternatively, capacitor banks are also sometimes used when a level of fault tolerance is desired; a single capacitor in the bank may fail and, as long as it has failed in the open state, the other capacitor or capacitors in the bank will still operate to provide a measure of capacitive compensation to the circuit. As used herein, Capacitive Compensation Circuit means any single capacitor or combination of capacitors, such as, for example, a capacitor bank.

Referring still to FIG. 1, Environmentally Controlled Switch 101 operates to place Capacitive Compensation Circuit 102 into or out of operation in the circuit as is clearly shown FIG. 1. When Environmentally Controlled Switch 101 is open, Capacitive Compensation Circuit 102 is switched out of operation. In this state, Capacitive Compensation Circuit 102 does not operate to provide optimization of the power requirements of the system.

However, when Environmentally Controlled Switch 101 is closed, Capacitive Compensation Circuit 102 is switched into operation. In this state, Capacitive Compensation Circuit 102 operates to provide optimization of the power requirements of the system.

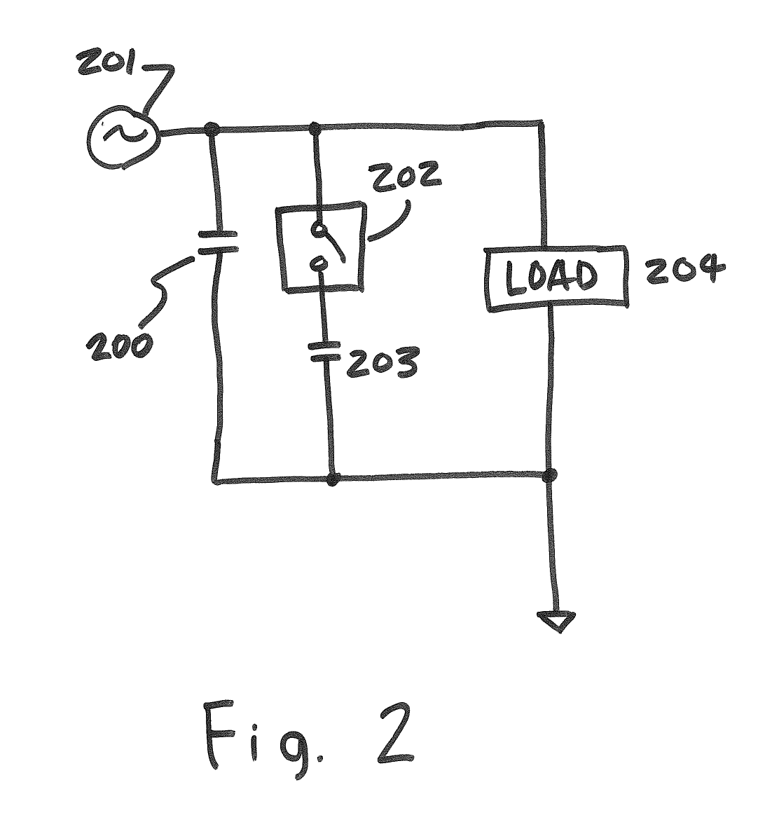

Referring now to FIG. 2, only a portion of the total of the total Capacitive Compensation Circuit is switched into or out of operation by Environmentally Controlled Switch 202. In this embodiment of the invention, only the portion of the Capacitive Compensation Circuit 203 is switched into or out of operation by Environmentally Controlled Switch 202; the portion of the Capacitive Compensation Circuit 200 is present in the circuit of the system at all times. Load 204 is therefore compensated at all times by Environmentally Controlled Switch 202, and is supplementally compensated by Capacitive Compensation Circuit 203 when Environmentally Controlled Switch 202 is closed.

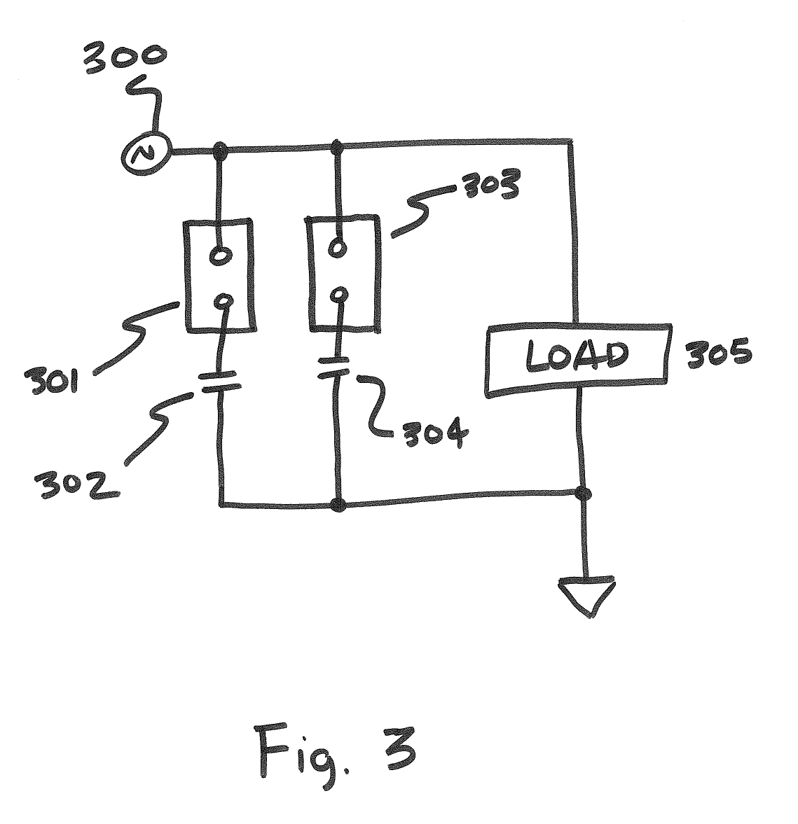

Referring now to FIG. 3, a plurality of Environmentally Controlled Switches 301 and 303 are utilized to place a plurality of Capacitive Compensation Circuits 302 and 304 into operation based upon the sensed environmental conditions. It is not necessary that Environmentally Controlled Switches 301 and 303 be of the same type. By way of example, and not as a limitation, Environmentally Controlled Switch 301 could be any environmentally controlled switch such as a thermostat, and Environmentally Controlled Switch 303 could be any environmentally controlled switch such as one that operates based upon barometric pressure.

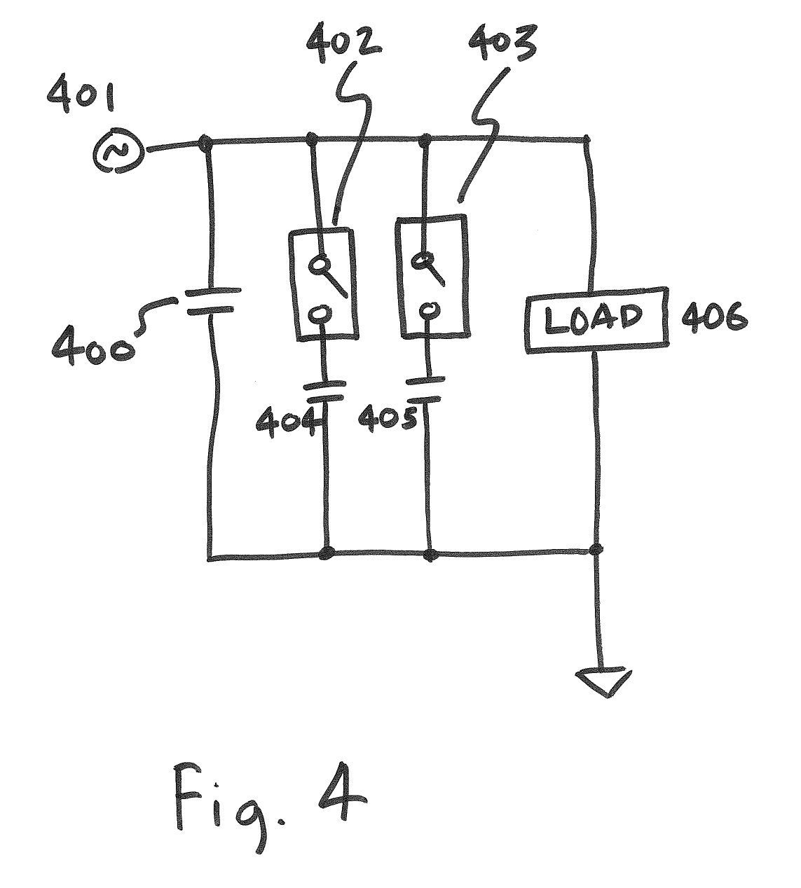

Referring now to FIG. 4, a plurality of Environmentally Controlled Switches 402 and 403 are utilized to place a plurality of Capacitive Compensation Circuits 404 and 405 into operation in parallel with a fixed capacitor 400. It is not necessary that Environmentally Controlled Switches 402 and 403 be of the same type. By way of example, and not as a limitation, Environmentally Controlled Switch 402 could be any environmentally controlled switch such as a thermostat, and Environmentally Controlled Switch 403 could be any environmentally controlled switch such as one that operates based upon barometric pressure.

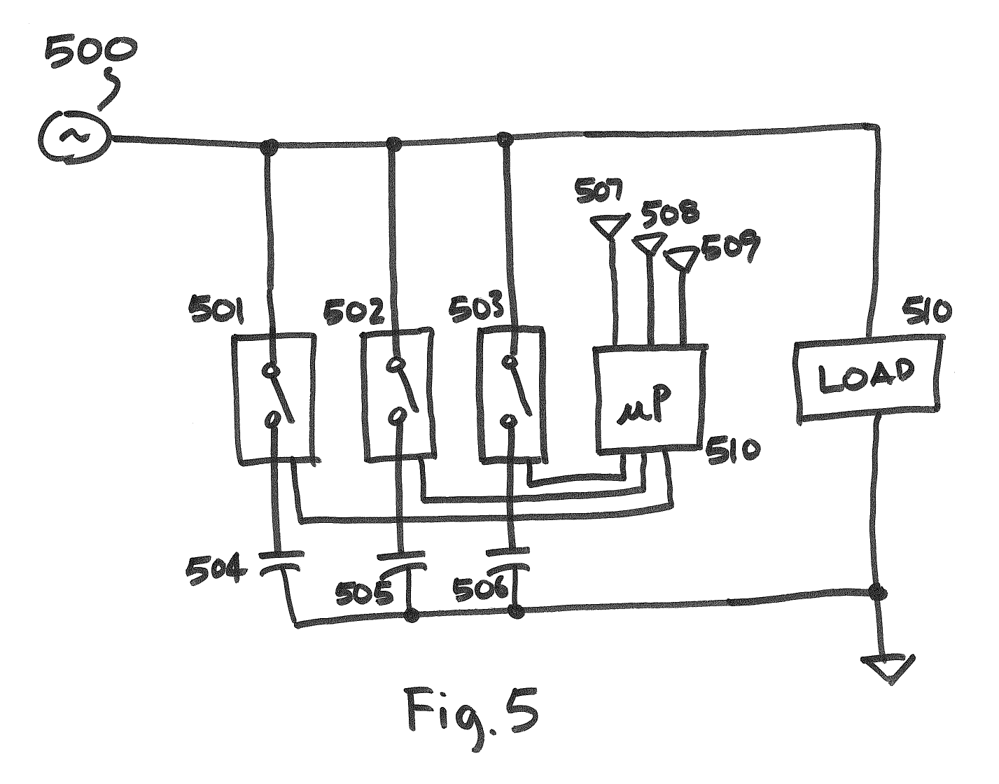

Referring now to the embodiment depicted in FIG. 5, decision circuit 510 is any electrical device which is programmable to provide an output based upon a set of input conditions, such as, for example, an analog computing circuit, a digital circuit, programmable logic devices, field programmable gate arrays, programmable logic arrays, discrete digital circuits, a microprocessor, or any like device or plurality of devices. Decision circuit 510 receives information such as temperature, humidity, barometric pressure, precipitation amounts, solar load, wind speed, or any other desired environmental parameter from environmental sensors 507, 508, and 509 and processes this information in accordance with the logic of the decision circuit 510. Decision circuit 510 then sets the state of its outputs to drive relays 501, 502, and 503 either open or closed thereby placing Capacitive Compensation Circuits into or out of operation in the circuit. It is understood that although FIG. 5 depicts three environmental inputs and three relays, any number of environmental inputs and any number of relays are within the scope of the invention.

It is easily understood that the loads of FIGS. 1 through 5 may be single loads or a plurality of loads, and that the embodiments of the invention described herein may be used in combination, and that all combinations thereof are within the scope of the invention.

It is also easily understood that, while Capacitive Compensation Circuits are shown in the various figures, other reactive elements are within the scope of the invention. For example, inductors may be utilized to offset a capacitive load. In these embodiments of the invention, the Capacitive Compensation Circuits described herein are Inductive Compensation Circuits which are switched into and out of operation by the Environmentally Controlled Switches of the invention.

Accordingly the reader will see that the present invention provides for a system and method for adjusting or otherwise optimizing capacitance in a system based on environmental conditions that affect the inductance in the system load. The power source may comprise a utility meter, a breaker from a panel, or any other power source known within the art.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A system for optimizing capacitance when attached to a power source and a load, comprising:
a environmentally controlled switch; and
one or more reactive circuit elements, wherein said one or more reactive circuit elements are disposed in electrical communication in parallel with said power source and said load.

2. The system of claim 1, wherein said reactive circuit elements are capacitors.

3. The system of claim 1, wherein said reactive circuit elements are inductors.

4. The system of claim 1, wherein said environmentally controlled switches are controlled by temperature.

5. The system of claim 1, wherein said environmentally controlled switches are controlled by humidity.

6. The system of claim 1, wherein said environmentally controlled switches are controlled by barometric pressure.

7. The system of claim 1, wherein said environmentally controlled switches are controlled by precipitation.

8. The system of claim 1, wherein said environmentally controlled switches are controlled by solar load.

9. The system of claim 1, wherein said environmentally controlled switches are controlled by wind speed.

10. The system of claim 2, wherein said environmentally controlled switches are controlled by temperature.

11. The system of claim 2, wherein said environmentally controlled switches are controlled by humidity.

12. The system of claim 2, wherein said environmentally controlled switches are controlled by barometric pressure.

13. The system of claim 2, wherein said environmentally controlled switches are controlled by precipitation.

14. The system of claim 2, wherein said environmentally controlled switches are controlled by solar load.

15. The system of claim 2, wherein said environmentally controlled switches are controlled by wind speed.

16. A system for optimizing reactive load when attached to a power source and a load, comprising:
a decision circuit;
at least one environmental sensor in electrical communication with said decision circuit;
at least one relay operated by said decision circuit and in electrical communication with said power source;
at least one reactive circuit elements in electrical communication with said at least one relay and in electrical communication with said load.

17. The system of claim 16, wherein said at least one reactive circuit element is a capacitor.

18. The system of claim 16, wherein said decision circuit is a microprocessor.

19. The system of claim 18, wherein said at least one reactive circuit element is a capacitor.
